(19) United States
(12) Patent Application Publication
(10) Pub. No.: US 2026/0088396 A1
(43) Pub. Date: Mar. 26, 2026

(54) PAD FOR BATTERY MODULE AND BATTERY MODULE

(71) Applicants: HYUNDAI MOTOR COMPANY, Seoul (KR); KIA CORPORATION, Seoul (KR); Industry-University Cooperation Foundation Hanyang University, Seoul (KR)

(72) Inventors: Jaeyoung Lim, Hwaseong-si (KR); YongHa Han, Hwaseong-si (KR); Hongyun So, Seoul (KR); Joohyung Bang, Seoul (KR); Byungkwon Chun, Seoul (KR)

(73) Assignees: HYUNDAI MOTOR COMPANY, Seoul (KR); KIA CORPORATION, Seoul (KR); Industry-University Cooperation Foundation Hanyang University, Seoul (KR)

(21) Appl. No.: 19/267,495

(22) Filed: Jul. 11, 2025

(30) Foreign Application Priority Data
Sep. 23, 2024 (KR) 10-2024-0127852

(51) Int. Cl. H01M 10/658; B32B 5/18; B32B 7/022; H01M 50/204; H01M 50/242; H01M 50/293

(52) U.S. Cl. CPC H01M 10/658; B32B 5/18; B32B 7/022; H01M 50/204; H01M 50/242; H01M 50/293; B32B 2266/0214; B32B 2307/304; B32B 2307/7376; B32B 2457/10

(57) ABSTRACT

The present disclosure relates to a pad for a battery module. The pad includes a laminate including a first polymer member, a buffer member disposed on the first polymer member, and a second polymer member disposed on the buffer member, wherein the first polymer member and the second polymer member have a porous lattice structure.

### CROSS-REFERENCE TO RELATED APPLICATION(S)

This application claims priority to and the benefit of Korean Patent Application No. 10-2024-0127852 filed in the Korean Intellectual Property Office on Sep. 23, 2024, the entire contents of which are incorporated herein by reference.

### TECHNICAL FIELD

The present disclosure relates to a pad for a battery module and a battery module.

### BACKGROUND

Unlike gasoline vehicles, electric vehicles are largely composed of a battery, an inverter (electric power conversion device), and a motor.

The battery is an energy storage device, and the electric power conversion device is a device that converts the electrical energy of the battery to generate driving torque, and this electrical energy is used to drive the motor to move the vehicle.

However, the battery may overheat or experience volume expansion (e.g., swelling) due to repeated charging and discharging processes or other causes, which may lead to safety issues such as internal battery short circuits or a fire.

In the past, polyurethane foam material was inserted between battery cells as a pad for the battery module to provide insulation and impact resistance. Recently, development of polyurethane materials with improved heat blocking performance is underway to increase insulation performance of polyurethane foam. However, polyurethane material has poor heat transfer performance, so when the battery cell overheats, it is difficult to effectively transfer the heat concentrated in the central portion of the cell to the cooling channel positioned at the bottom of the battery module.

### SUMMARY

Accordingly, the present disclosure is to provide a pad for a battery module that may (e.g., efficiently) absorb impact caused by mechanical deformation, such as battery cell volume expansion (swelling), and also has improved heat transfer efficiency so that heat generated when the battery cell is overheated may be (e.g., efficiently) discharged to the outside of the battery module.

One embodiment of the present disclosure provides a pad for a battery module, wherein the pad is a laminate comprising a first polymer member. The pad includes a buffer member disposed on the first polymer member, and a second polymer member disposed on the buffer member. The first polymer member, the second polymer member, and the buffer member have a porous structure. The average size of the pores in the first polymer member and the average size of the pores in the second polymer member are larger than the average size of the pores in the buffer member. The first polymer member and the second polymer member have a lattice structure.

The first polymer member and the second polymer member may have a structure including a plurality of porous lattice structures having the same shape, and the plurality of porous lattice structures are laminated in a thickness direction.

The first polymer member and the second polymer member may each have a pore area ratio per unit area in a plane perpendicular to the thickness direction greater than the pore area ratio per unit area in a plane perpendicular to a lateral direction.

The first polymer member and the second polymer member may be positioned and used so that the plane perpendicular to the thickness direction is in contact with the battery cell (e.g., respectively).

When the pad for the battery module is heated, the amount of heat transfer in the lateral direction may be greater than the amount of heat transfer in the thickness direction.

The pore area ratio per unit area of the surface perpendicular to the thickness direction may be greater than 50%.

The pore area ratio per unit area of the surface perpendicular to the lateral direction may be less than 45%.

The thickness of the buffer member may be 30% to 70% of the pad thickness for the battery module.

The ratio of the thickness of the first polymer member to the thickness of the second polymer member (e.g., first polymer member:second polymer member) may be 4:6 to 6:4.

The buffer member may include polyurethane foam, polypropylene foam, polystyrene foam, polyethylene foam, or a combination thereof.

The first polymer member and the second polymer member may each (e.g., independently) include polydimethylsiloxane (PDMS), Ecoflex, thermoplastic Polyurethane (TPU) or combinations thereof. The first polymer member and the second polymer member may be cast into a mold.

Another embodiment of the present disclosure provides a battery module. The battery module includes a cell laminate including a plurality of battery cells, wherein the plurality of battery cells are stacked. The battery module also includes a pad for the battery module. The pad is placed between at least one pair of adjacent battery cells of the plurality of battery cells. The pad for the battery module is a laminate including a first polymer member, a buffer member disposed on the first polymer member, and a second polymer member disposed on the buffer member. The first polymer member, the second polymer member, and the buffer member have a porous structure. An average size of pores in the first polymer member and an average size of pores in the second polymer member are larger than an average size of pores in the buffer member. The first polymer member and the second polymer member have a lattice structure.

The first polymer member and the second polymer member may have a structure including a plurality of porous lattice structures having the same shape, and the plurality of porous lattice structures are laminated in the thickness direction.

Each of the first polymer member and the second polymer member may have a pore area ratio per unit area in a plane perpendicular to the thickness direction greater than the pore area ratio per unit area in a plane perpendicular to the lateral direction.

The first polymer member and the second polymer member may be positioned so that the plane perpendicular to the thickness direction is in contact with the battery cell, respectively.

A pad for a battery module according to an embodiment of the present disclosure (e.g., efficiently) absorbs impact caused by mechanical deformation such as battery cell volume expansion (e.g., swelling), and also has improved heat transfer efficiency so that heat generated when the battery cell is overheated may be (e.g., efficiently) discharged to the outside of the battery module.

### BRIEF DESCRIPTION OF THE DRAWINGS

FIG. 1 is a schematic cross-sectional view of a pad for a battery module according to an embodiment of the present disclosure.

FIG. 2 is a schematic cross-sectional view of a battery module according to another embodiment of the present disclosure.

FIG. 3 is a schematic view of a perspective view of a pad for a battery module according to an embodiment of the present disclosure.

FIG. 4 is a schematic view showing a perspective view of a polymer member according to the present disclosure.

FIG. 5 schematically illustrates a manufacturing method of the first polymer member or second polymer member according to the present disclosure.

FIG. 6 is a photograph of a polymer member manufactured according to Preparation Example 1.

FIG. 7 is a SEM image taken in the thickness direction of a polymer member manufactured according to Preparation Example 1.

FIG. 8 is a SEM image of a polymer member manufactured according to Preparation Example 1, taken in the thickness direction and the perpendicular plane direction.

FIG. 9 is a plan view of the filament mold used in the manufacture of the polymer member of Preparation Example 1.

FIG. 10 is a result graph of the impact performance evaluation for the pad for the battery module of the embodiment and comparative example.

FIG. 11 is an IR camera image of results of evaluating the heat transfer performance of the pad for the battery module of an embodiment 1, an embodiment 2, a comparative example 1, and a comparative example 2.

FIG. 12 is a schematic view showing the method for evaluating the anisotropic heat transfer performance of a polymer member according to Experimental Example 5.

FIG. 13 is an IR camera image showing the results of evaluating the anisotropic heat transfer performance of the polymer member in a direction 1 and a direction 2 according to Experimental Example 5.

FIG. 14 is a result graph of the evaluation of the anisotropic heat transfer performance of the polymer member according to Experimental Example 5.

### DETAILED DESCRIPTION

The terms first, second, and third are used to describe, but are not limited to, various parts, components, regions, layers, and/or sections. These terms are used to distinguish one part, component, region, layer or section from another part, component, region, layer or section. Accordingly, the first part, component, region, layer or section described herein may be referred to as the second part, component, region, layer or section within a scope of the present disclosure.

The terminology used herein is for the purpose of referring to particular embodiments and is not intended to limit the present disclosure. The singular forms used here also include the plural forms unless the phrases indicate a contrary meaning. The term “comprising, including, having, containing” as used in the specification may provide a particular characteristic, region, integer, step, operation, element and/or component, and does not preclude the presence or addition of other characteristic, region, integer, step, operation, element, and/or component.

When it is said that a part is “on” or “over” another part, it may be directly on or over the other part, or there may be other parts involved. In contrast, when a part is said to be “directly on” another part, no other part intervenes.

Although not otherwise defined, terms, including technical and scientific terms, used herein have the same meaning as is generally understood by a person of ordinary skill in the art to which the present disclosure belongs. Terms defined in commonly used dictionaries are additionally interpreted to have a meaning consistent with the relevant technical literature and the present disclosure, and are not to be interpreted in a very formal sense unless otherwise defined.

Also, unless otherwise stated, % means wt %, and 1 ppm is 0.0001 wt %.

In this specification, the term “combination thereof(s)” may include one or more mixtures or combinations selected from the group of components, and may include one or more selected from the group consisting of the components.

Below, an embodiment is described in detail so that a person of ordinary skill in the technical field to which the present disclosure belongs may carry out the present disclosure. As those skilled in the art would realize, the described embodiments may be modified in various different ways, without departing from the spirit or scope of the present disclosure.

One embodiment of the present disclosure provides a pad for a battery module. The pad may be a laminate including a first polymer member, a buffer member disposed on the first polymer member, and a second polymer member disposed on the buffer member. The first polymer member, the second polymer member, and the buffer member have a porous structure. The average size of the pores in the first polymer member and the average size of the pores in the second polymer member are larger than the average size of the pores in the buffer member. The first polymer member and the second polymer member have a lattice structure.

A pad for a battery module according to one embodiment of the present disclosure includes a buffer member and a polymer member, thereby (e.g., efficiently) absorbing impact due to mechanical deformation, such as battery cell volume expansion (e.g., swelling). The pad also has improved heat transfer efficiency so that heat generated when the battery cell is overheated may be (e.g., efficiently) discharged to the outside of the battery module.

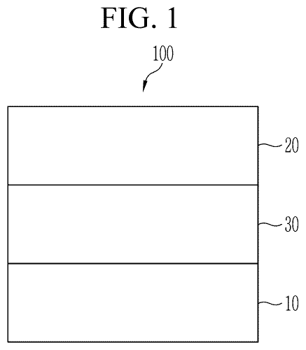

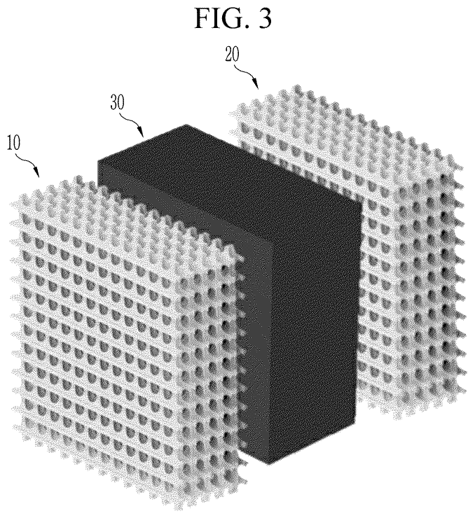

FIG. 1 is a schematic cross-sectional view of a pad for a battery module according to an embodiment of the present disclosure. FIG. 3 is a schematic view of a perspective view of a pad for a battery module according to an embodiment of the present disclosure.

Referring to FIG. 1 and FIG. 3, a pad for a battery module according to one embodiment of the present disclosure is a laminate including a first polymer member 10, a buffer member 3 disposed on the first polymer (e.g., substrate) member, and a second polymer member 20.

The buffer member has improved impact resistance and may efficiently absorb impact caused by mechanical deformation, such as swelling of a battery cell. Accordingly, safety may be improved by preventing battery damage, short circuits, and/or the like.

The buffer member may include, for example, polyurethane foam, polypropylene foam, polystyrene foam, polyethylene foam, or a combination thereof.

Current buffer members may be a pad, wherein the pad is provided as a material with low heat transfer performance, which may create a problem in that the heat generated when the battery cell overheats is not efficiently discharged to the outside of the battery module when using (e.g., a single current) buffer members as a pad for the battery module.

Thus, the present disclosure is a pad for a battery module according includes a first polymer member 10 and a second polymer member 20.

Particularly, the first polymer member, the second polymer member, and the buffer member may have a porous structure, wherein the ratio of the thickness direction pore area within the first polymer member and the second polymer member is higher than the ratio of the lateral direction pore area. Since the lateral direction pore ratio of the first polymer member and the second polymer member is smaller than the thickness direction pore ratio, improved heat transfer efficiency may be achieved (e.g., compared to the thickness direction), so that the heat generated by the battery cell may be (e.g., efficiently) discharged to the outside. For example, heat transfer may be broadly divided into heat transfer by conduction and heat transfer by convection. Conduction refers to the transfer of heat energy by the vibration of particles between solid materials with different temperatures, while convection refers to the transfer of heat energy by the movement of particles in a liquid or gas as a supply of heat. At this time, compared to general solid materials, porous solids with internal pores have insulating properties due to the heat blocking effect of the air layer. Since the insulation performance increases as the pore ratio increases, the heat transfer efficiency is more enhanced on the side with a low pore ratio than on the side with a high pore ratio. Therefore, the heat transfer efficiency in the vertical direction on the side of the first polymer member and the second polymer member is greater relative to the heat transfer efficiency in the vertical direction at a thickness with a higher pore area ratio. Accordingly, the pad for a battery module according to the present disclosure may (e.g., efficiently) discharge heat generated by a battery cell to the outside by including a first polymer member and a second polymer member in addition to a buffer member.

In this specification, the average size of pores in a polymer member or buffer member may be measured by taking and analyzing a surface image of the member.

For example, the average size of the pores in the first polymer member may be 200 μm to 400 μm, and the average size of the pores in the second polymer member may be 200 μm to 400 μm. Additionally, the average size of the pores within the buffer member may be 50 μm to 200 μm. When the average size of the pores in the first polymer member, the second polymer member, and the buffer member are within the (e.g., provided) range, the battery cell heat discharge performance may be improved.

Additionally, the first polymer member and the second polymer member may have a porous lattice structure and may have an anisotropic lattice structure with different structures depending on the direction.

That is, the first polymer member and the second polymer member may have a structure in which a plurality of porous lattice structures (e.g., of the same shape) are laminated in the thickness direction. Accordingly, the first polymer member and the second polymer member may each have anisotropic lattice structures with different structures along the plane direction.

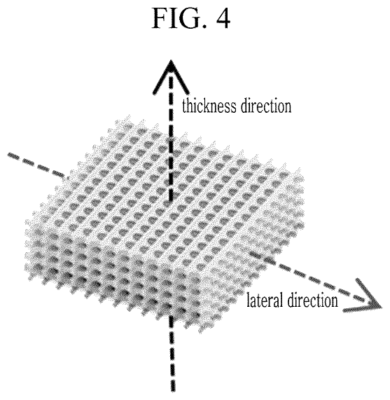

FIG. 4 is a schematic view showing a perspective view of a polymer member (e.g., the first polymer member or the second polymer member) according to the present disclosure.

Referring to FIG. 4, the anisotropic lattice structure, the first polymer member and the second polymer member may have a pore area ratio per unit area of a plane perpendicular to the thickness direction greater than a pore area ratio per unit area of a plane perpendicular to the lateral direction, respectively.

In this disclosure, “thickness direction” (e.g., vertical direction) may be a straight line direction that sequentially connects the first polymer member, the buffer member, and the second polymer member in the pad for the battery module, and is (e.g., substantially) perpendicular to the bottom surface of the polymer member. Additionally, “lateral direction” may be a direction that is (e.g., substantially) orthogonal to the thickness direction, but is (e.g., substantially) perpendicular to the side of the polymer member.

As the pore area ratio per unit area of the plane perpendicular to the thickness direction is greater than the pore area ratio per unit area of the plane perpendicular to the lateral direction, heat transfer in the lateral direction may be greater than that in the thickness direction. In addition, since the lateral direction is a direction toward the outside of the battery module rather than a direction toward the battery cell when viewed from the battery module unit, the heat generated in the battery cell may be discharged more efficiently to the outside of the battery module. As a result, since the polymer member according to the present disclosure has the anisotropic lattice structure as described above, the discharge direction of heat generated in the battery cell may be induced toward the outside of the battery module, thereby improving heat discharge efficiency.

Additionally, the first polymer member and the second polymer member may be positioned and used so that the plane perpendicular to the thickness direction is in contact with the battery cell, respectively. In the battery module unit, when the contact position relationship between the pad for the battery module and the battery cell is as described above, the lateral direction (e.g., the side direction) inside the polymer member becomes the external direction of the battery module, so that heat discharge may occur efficiently. That is, when the pad for the battery module is heated, the amount of heat transfer in the lateral direction may be greater than the amount of heat transfer in the thickness direction.

Meanwhile, in this specification, the “pore area ratio per unit area” may be measured by taking and analyzing a surface image of the member.

For example, the pore area ratio per unit area of the plane perpendicular to the thickness direction may be greater than 50%. Additionally, the pore area ratio per unit area of the surface perpendicular to the lateral direction may be less than 45%. When the pore area ratio per unit area of the plane perpendicular to the thickness direction and the plane perpendicular to the lateral direction satisfy the range, the previously mentioned battery cell generated heat discharge efficiency may be (e.g., more preferably) implemented.

Additionally, the thickness of the buffer member may be 30% to 70% of the pad entire thickness reference for the battery module, or may be 30% to 50%. If the thickness of the buffer member is too thin, the content of the buffer member may be too low, and there may be a problem in that the impact caused by mechanical deformation such as battery cell volume expansion (e.g., swelling) may not be (e.g., efficiently) absorbed. If the thickness of the buffer member is too thick, the heat transfer efficiency may be too low with the content of the polymer member, which may cause a problem in that the heat generated by the battery cell may not be (e.g., efficiently) discharged to the outside of the battery module.

The first polymer member and the second polymer member may each independently include polydimethylsiloxane (PDMS), Ecoflex, thermoplastic Polyurethane (TPU), or a combination thereof. For example, the first polymer member and the second polymer member may include polydimethylsiloxane (PDMS). Using PDMS as a polymer member material, may improve flexibility and enhance heat transfer.

A pad for a battery module according to one embodiment of the present disclosure may be manufactured by (e.g., sequentially) laminating the first polymer member, the buffer member, and the second polymer member, respectively.

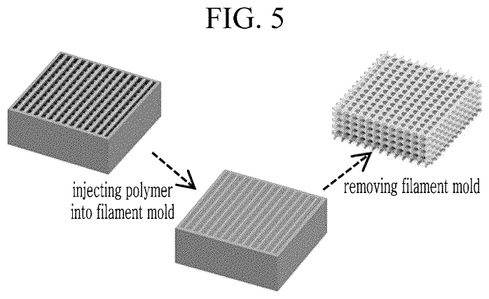

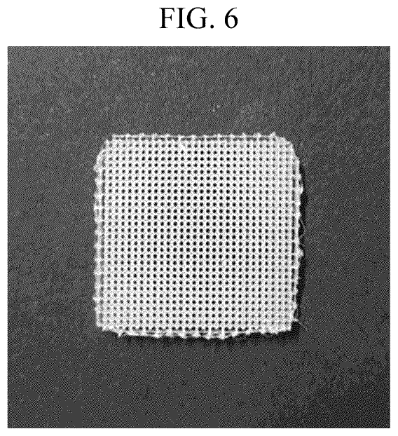

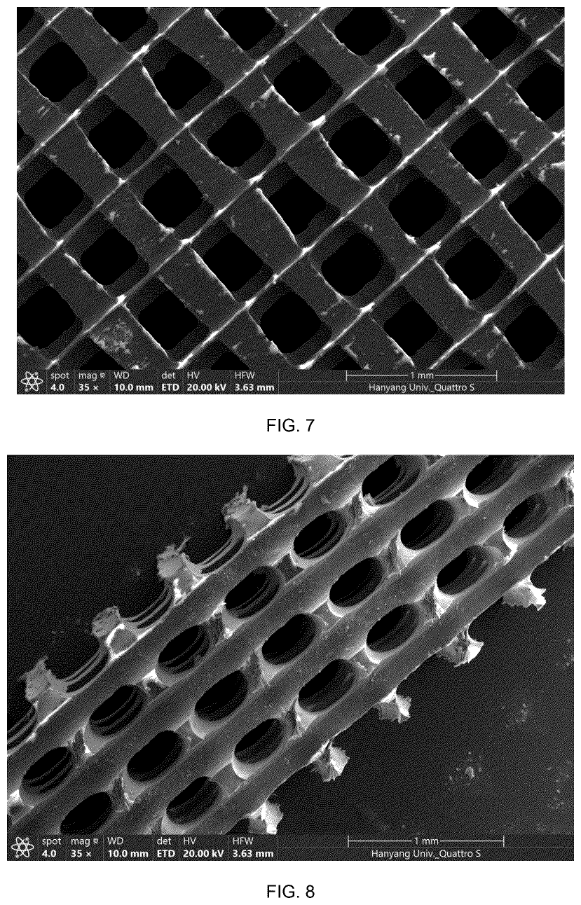

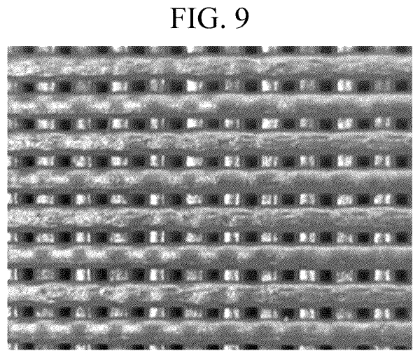

FIG. 5 schematically illustrates a manufacturing method of the first polymer member or second polymer member according to the present disclosure.

Referring to FIG. 5, the polymer member (e.g., first polymer member or second polymer member) according to the present disclosure may be manufactured by preparing a filament mold having a frame of a lattice structure, inserting a polymer member forming solution into the filament mold and then drying it, and removing the filament mold.

The preparation of the filament mold may be, for example, preparing a filament mold of a lattice structure through 3D printing. For example, the filament mold may be manufactured by manufacturing a single-layer filament mold of a unit lattice structure and then laminating it in the vertical (e.g., thickness) direction.

Forming the polymer member may include providing a polymer material that becomes the material of the polymer member, a hardener for the polymer liquid material, an additive for enhancing heat transfer efficiency, and a phase change additive for increasing cooling efficiency.

The polymer material may include polydimethylsiloxane (PDMS), Ecoflex, thermoplastic polyurethane (TPU), or a combination thereof.

The removal of the filament mold may be performed by dissolving it in a solvent such as acetone.

Accordingly, a polymer member (e.g., first polymer member or second polymer member) according to the present disclosure may be prepared.

Thereafter, a pad for a battery module according to the present disclosure may be manufactured by (e.g., sequentially) laminating the first polymer member, the buffer member, and the second polymer member.

The lamination method may be performed in a generally-used manner. For example, the lamination may be performed by lamination and junction through thermal distortion and softening of the material, but is not limited thereto.

Another embodiment of the present disclosure provides a battery module. The battery module includes a cell laminate in which a plurality of battery cells are stacked. The battery module includes a pad for the battery module is placed between at least one pair of adjacent battery cells of the plurality of battery cells, and the pad for the battery module is a laminate including a first polymer member. The battery module further includes a buffer member disposed on the first polymer member, and a second polymer member disposed on the buffer member. The first polymer member, the second polymer member, and the buffer member have a porous structure, and an average size of pores in the first polymer member and the average size of pores in the second polymer member is larger than an average size of pores in the buffer member. Also, the first polymer member and the second polymer member have a lattice structure.

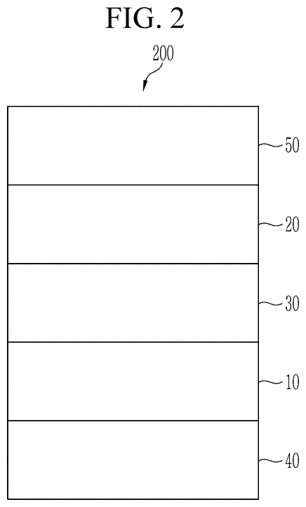

FIG. 2 is a schematic cross-sectional view of a battery module according to another embodiment of the present disclosure.

Referring to FIG. 2, another embodiment of the present disclosure provides a battery module (200), wherein a pad for the battery module is disposed between battery cells (40, 50). The pad for the battery module is a laminate including a first polymer member (10), a buffer member (30) disposed on the first polymer substrate, and a second polymer member (20) disposed on the buffer member.

The configuration of the pad for the battery module is the same or substantially similar as described above, so the configuration description is omitted.

Any other configuration of the battery module, such as the battery cell, may be used without any (e.g., particular) restrictions.

According to another embodiment of the present disclosure, a battery module includes a pad for a battery module, thereby having improved impact resistance and also having an improved cooling function by (e.g., efficiently) discharging heat generated to the outside when a battery cell overheats.

Below, an example of the present disclosure is described in more detail. However, the following embodiment is an example, and the present disclosure is not limited by the following example.

### Preparation Example 1: Polymer Member Manufacturing

A polymer member was manufactured by mixing a hardener solution into a polymer subject solution, pouring it into a mold, and hardening it, or by dissolving a polymer material in a solution, pouring it into a mold, and evaporating the solution.

### Preparation Example 2: Manufacturing a Buffer Member

The buffer member was manufactured by mixing polyol (e.g., polyester or polyethylene glycol), isocyanate (e.g., polymethyldiphenyl diisocyanate), a forming agent, an accelerator, an antioxidant, and other additives, and then expanding the mixture into a foam state by the action of the forming agent.

### Embodiment 1

The polymer member of Preparation Example 1 was prepared by adjusting the thickness to 2.5 mm and forming two polymer members (e.g., first polymer member, second polymer member). The buffer member of Preparation Example 2 was prepared by adjusting the thickness of the buffer member to 10 mm.

Afterwards, the uncured polymer was sequentially applied between the polymer member and the buffer member in the order of the first polymer member, buffer member, and second polymer member to form a junction. Alternatively, the buffer member is placed and cured before the polymer member is cured in the mold. Alternatively, the junction was made using temperature conditions. Pads for battery modules were manufactured by laminating using various methods such as these.

### Embodiment 2

The polymer member of Preparation Example 1 was prepared by adjusting the thickness to 5 mm and forming two polymer members (e.g., first polymer member, second polymer member). The buffer member of Preparation Example 2 was prepared by adjusting the thickness of the buffer member to 5 mm.

Afterwards, the uncured polymer was sequentially applied between the polymer member and the buffer member in the order of the first polymer member, buffer member, and second polymer member to form a junction. Alternatively, the buffer member is placed and cured before the polymer member is cured in the mold. Alternatively, the junction was made using temperature conditions. Pads for battery modules were manufactured by laminating using various methods such as these.

### Comparative Example 1

The buffer member of Preparation Example 2 was adjusted to a thickness of 15 mm and used as a pad for the battery module.

### Comparative Example 2

The polymer member of Preparation Example 1 was prepared with three polymer members by adjusting the thickness to 5 mm.

Afterwards, the three polymer members were sequentially laminated using a method of applying the polymer before curing between the junctions to manufacture a pad for a battery module.

### Experimental Example 1: Evaluation of Average Pore Size within Polymer Member and Buffer Member

The average pore size in the polymer member of porous Preparation Example 1 and the buffer member of porous Preparation Example 2 was evaluated, and the results are shown in Table 1 below.

The surface image of the member was captured and analyzed to measure the average pore size within the member.

TABLE 1

| | average pore size (μm) |
|---|---|
| polymer member | 300 |
| Buffer member | 125 |

Referring to Table 1, it was confirmed that the average pore size of the polymer member was larger than the average pore size of the buffer member.

### Experimental Example 2: Evaluation of Anisotropic Lattice Structure of Polymer Member

For the polymer member of Preparation Example 1, the pore area ratio per unit area in the plane perpendicular to the thickness direction and the pore area ratio per unit area in the plane perpendicular to the lateral direction were evaluated, and the results are shown in Table 2 below.

The surface image of the member was captured and analyzed to measure the pore area ratio per unit area.

TABLE 2

| polymer member | Pore area ratio per unit area (%) |
|---|---|
| The plane perpendicular to the | 55 |
| thickness direction | |
| The plane perpendicular to the | 40 |
| lateral direction | |

Referring to Table 2, it was confirmed that the pore area ratio per unit area of the plane perpendicular to the thickness direction of the polymer member was higher than the pore area ratio per unit area of the plane perpendicular to the lateral direction of the polymer member.

### Experimental Example 3: Evaluation of My Impact Performance

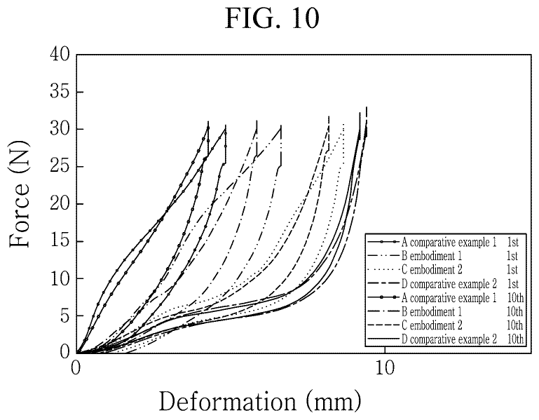

For the pads for the battery module of the embodiment and comparative example, the impact performance was evaluated and is shown in FIG. 10 and Table 3 below.

The same load of 30 N was (e.g., repeatedly) applied 10 times to the pads for the battery modules of the embodiment and the comparative example, and the deformation behavior for each load was compared and analyzed.

In FIG. 10, A represents Comparative Example 1, B represents embodiment 1, C represents embodiment 2, and D represents Comparative Example 2.

TABLE 3

| | Buffer member | | |
|---|---|---|---|
| | thickness ratio (%) | | Increase in |
| | (Buffer member | | hysteresis loop |
| | thickness/pad | Transformation | region area |
| | entire thickness) | length (mm) | (mmN) |
| Comparative | 100 | 4.28 | 26.04 |
| Example 1 | | | |
| embodiment 1 | 66.67 | 5.85 | 23.35 |
| embodiment 2 | 33.33 | 8.18 | 20.97 |
| Comparative | 0 | 9.18 | 11.69 |
| Example 2 | | | |

Referring to FIG. 10 and Table 3, it was confirmed that as the thickness ratio of the (e.g., polyurethane foam) buffer member increased, the deformation length decreased, and the hysteresis loop region width also tended to increase. Therefore, from the viewpoint of preventing energy loss and excessive deformation of the buffer member material, it was confirmed that embodiment 1 and embodiment 2 were suitable.

### Experimental Example 4: Evaluation of Heat Transfer Performance

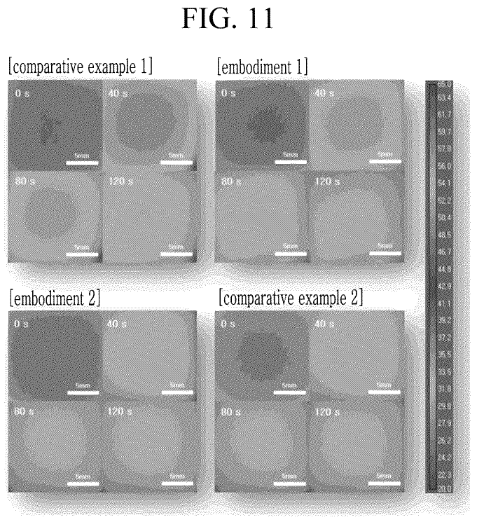

For the pads for the battery module of the embodiment and comparative example, the heat transfer performance was evaluated and is shown in FIG. 11 and Table 4 below.

The pads for the battery modules of the embodiment and the comparative example were heated simultaneously, and the temperature at the top of the specimen was measured at regular time intervals using an IR camera image, which is shown in FIG. 11. At this time, the time taken for the specimen to reach 45° C. was measured, and this is shown in Table 4 below.

TABLE 4

| | Buffer member thickness ratio (%) | |
|---|---|---|
| | (Buffer member thickness/pad entire | Time to reach |
| | thickness) | 45° C. (sec) |
| Comparative | 100 | 240 |
| Example 1 | | |
| embodiment 1 | 66.67 | 210 |
| embodiment 2 | 33.33 | 150 |
| Comparative | 0 | 90 |
| Example 2 | | |

Referring to FIG. 11 and Table 4, it was confirmed that as the thickness ratio of the polyurethane foam buffer member decreases, the temperature rises (e.g., more quickly) due to heating. Through this, it was confirmed that the heat transfer performance increased as the polymer member content increased. Therefore, it was confirmed that embodiment 2 and Comparative Example 2 were suitable from the perspective of heat transfer performance.

### Experimental Example 5: Evaluation of Anisotropic Heat Transfer Performance of Polymer Members

In order to confirm the greatest heat transfer efficiency in a specific direction due to the anisotropic lattice structure of the polymer member of Preparation Example 1, a heat transfer performance experiment for each direction of the polymer member itself was conducted.

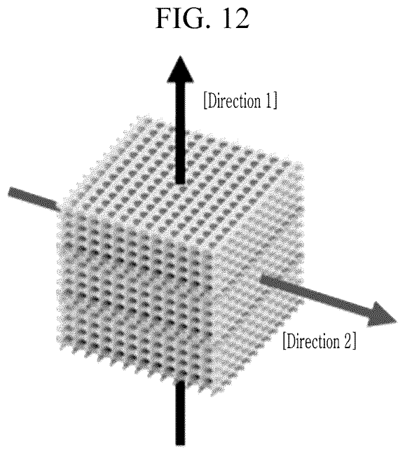

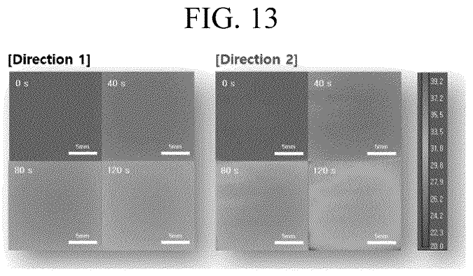

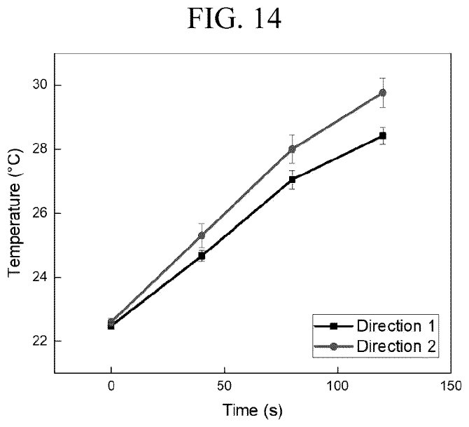

As shown in FIG. 12, heating was performed in the thickness direction (e.g., Direction 1) and the lateral direction (e.g., Direction 2) for each polymer member, and the temperature change at the top of each polymer member specimen over time was measured using an IR camera image, and is shown in FIG. 13 and FIG. 14.

Referring to FIG. 13 and FIG. 14, it was confirmed that the temperature change when heating in the lateral direction (e.g., Direction 2) was greater than the temperature change when heating in the thickness direction (e.g., Direction 1), confirming that the heat transfer performance in the lateral direction was better.

Therefore, when applying a pad for a battery module to a battery module, it is predicted that when the polymer member surface perpendicular to the thickness direction is inserted and positioned so that it contacts the battery cell, the heat generated by the battery cell is (e.g., efficiently) transferred to the lateral direction (e.g., the external direction of the battery cell), thereby causing an efficient heat discharge effect.

Although the present disclosure has been described above with regard to example embodiments thereof, the present disclosure is not limited thereto, and it is possible to implement the present disclosure by modifying it in various ways within the scope of the disclosure herein and accompanying drawings of the disclosure. This naturally falls within the scope of the present disclosure.

Therefore, it may be said that the scope of the present disclosure is provided by the attached patent claims and their equivalents.

What is claimed is:

1. A pad for a battery module, the pad comprising:
a laminate including
a first polymer member,
a buffer member disposed on the first polymer member, and
a second polymer member disposed on the buffer member,
wherein
the first polymer member, the second polymer member and the buffer member have a porous structure, and
an average size of pores in the first polymer member is larger than an average size of pores in the buffer member or an average size of pores in the second polymer member is larger than the average size of the pores in the buffer member, and
the first polymer member and the second polymer member have a lattice structure.

2. The pad of claim 1, wherein:
the first polymer member and the second polymer member have a structure of a plurality of porous lattice structures laminated in a thickness direction, and a shape of each porous lattice structure of the plurality of porous lattice structures is the same.

3. The pad of claim 1, wherein:
the first polymer member and the second polymer member have a pore area ratio per unit area perpendicular to a thickness direction greater than the pore area ratio per unit area perpendicular to a lateral direction.

4. The pad of claim 1, wherein:
the first polymer member and the second polymer member are positioned so that a plane perpendicular to a thickness direction is in contact with a battery cell.

5. The pad of claim 1, wherein:
when the pad for the battery module is heated, an amount of heat transfer in a lateral direction is greater than an amount of heat transfer in a thickness direction.

6. The pad of claim 3, wherein:
a pore area ratio per unit area of a surface perpendicular to the thickness direction is 50% or more.

7. The pad of claim 3, wherein:
a pore area ratio per unit area of a surface perpendicular to the lateral direction is 45% or less.

8. The pad of claim 1, wherein:
a thickness of the buffer member is 30% to 70% of an entire thickness of the pad for the battery module.

9. The pad of claim 1, wherein:
a ratio of a thickness of the first polymer member and a thickness of the second polymer member (first polymer member:second polymer member) is 4:6 to 6:4.

10. The pad of claim 1, wherein:
the buffer member includes polyurethane foam, polypropylene foam, polystyrene foam, polyethylene foam, or a combination thereof.

11. The pad of claim 1, wherein:
the first polymer member includes polydimethylsiloxane (PDMS), Ecoflex, thermoplastic Polyurethane (TPU), or a combination thereof.

12. The pad of claim 1, wherein:
the second polymer member includes polydimethylsiloxane (PDMS), Ecoflex, thermoplastic Polyurethane (TPU) or a combination thereof.

13. A battery module, comprising:
a cell laminate in which a plurality of battery cells is stacked; and
a pad for the battery module positioned between at least one pair of adjacent battery cells of the plurality of battery cells, and
the pad for the battery module is a laminate including
a first polymer member,
a buffer member disposed on the first polymer member, and
a second polymer member disposed on the buffer member,
wherein the first polymer member, the second polymer member, and the buffer member have a porous structure, and
an average size of pores in the first polymer member and an average size of pores the second polymer member is larger than an average size of pores in the buffer member, and
the first polymer member and the second polymer member have a lattice structure.

14. The battery module of claim 13, wherein:
the first polymer member and the second polymer member have a plurality of porous lattice structures laminated in a thickness direction, and wherein a shape of each porous lattice structure of the plurality of porous lattice structures is the same.

15. The battery module of claim 13, wherein:
the first polymer member has a pore area ratio per unit area perpendicular to a thickness direction greater than the pore area ratio per unit area perpendicular to a lateral direction.

16. The battery module of claim 13, wherein:
the second polymer member has a pore area ratio per unit area perpendicular to a thickness direction greater than the pore area ratio per unit area perpendicular to a lateral direction.

17. The battery module of claim 13, wherein:
the first polymer member is positioned so that a plane perpendicular to a thickness direction is in contact with a battery cell.

18. The battery module of claim 13, wherein:
the second polymer member is positioned so that a plane perpendicular to a thickness direction is in contact with the battery cell.

19. The battery module of claim 13, wherein:
the first polymer member includes polydimethylsiloxane (PDMS), Ecoflex, thermoplastic Polyurethane (TPU), or a combination thereof.

20. The battery module of claim 13, wherein:
the second polymer member includes polydimethylsiloxane (PDMS), Ecoflex, thermoplastic Polyurethane (TPU), or a combination thereof.
